(19) United States
(12) Patent Application Publication
(10) Pub. No.: US 2020/0080599 A1
(43) Pub. Date: Mar. 12, 2020

(54) GEARBOX CLUTCH SUPPORT STRUCTURE

(71) Applicant: EFNEO SP.Z O.O., Warszawa (PL)

(72) Inventors: Wiktor MIGASZEWSKI, Warszawa (PL); Franciszek MIGASZEWSKI, Warszawa (PL); Stefan MIGASZEWSKI, Grodzisk Mazowiecki (PL)

(21) Appl. No.: 16/478,785

(22) PCT Filed: Feb. 2, 2018
(86) PCT No.: PCT/PL2018/000012

§ 371 Date: Jul. 17, 2019

(30) Foreign Application Priority Data
Feb. 15, 2017 (PL) P.420541

(51) Int. Cl. F16D 23/00; B62M 11/14; F16D 11/00

(52) U.S. Cl. CPC F16D 23/00; F16D 11/00; B62M 11/145

(57) ABSTRACT

The gearbox clutch support structure containing a crank, a crank bearing, a clutch pipe, a leverage and a bottom bracket cup characterized in that it contains said crank bearing (2) that is mounted in said crank (1) and it contains said clutch pipe (3) that is mounted inside of said crank bearing (2), wherein said clutch pipe (3) is rigidly fixed to said leverage (4), wherein said leverage (4) is mounted on said bottom bracket cup (5).

The invention relates to a gearbox clutch support structure, usable as basis for clutch elements in epicyclic gearboxes mounted on the bicycle bottom bracket axle.

The gearbox clutch support structure is known from patent description JP 62099293, where clutch support structure is used as a bottom bracket cup. This requires it to be installed first, before the rest of the gearbox mechanism, which makes the whole installation process very complex. In a gearbox clutch support structure known from patent description U.S. Pat. No. 4,854,191 the support structure is not mounted inside of a crank bearing.

The essence of invention is development of such a gearbox clutch support structure that is very stable, also under high forces. The essence of invention is also development of such a gearbox clutch support structure that offers ease of assembly on a bicycle—the gearbox is just put on a bottom bracket cup and axle, in a single operation, without opening the gearbox case.

The gearbox clutch support structure according to the invention is characterized in that it contains a crank bearing that is mounted in a crank and it contains a clutch pipe that is mounted inside of said crank bearing, wherein said clutch pipe is rigidly fixed to a leverage, wherein said leverage is mounted on a bottom bracket cup.

It is preferable, that the gearbox clutch support structure contains said leverage which contains a blockade.

It is preferable, that the gearbox clutch support structure contains said clutch pipe which is used as a basis for other clutch elements.

It is preferable, that the gearbox clutch support structure contains said leverage which rotation in relation to said clutch pipe is blocked by a spline.

It is preferable, that the gearbox clutch support structure contains said leverage which is fixed to said clutch pipe with leverage bolts.

It is preferable, that the gearbox clutch support structure contains a leverage ring which has an internal diameter, which is equal to the outer diameter of said bottom bracket cup.

It is preferable, that the gearbox clutch support structure contains said clutch pipe which movement away from said crank is constrained by a yoke.

It is preferable, that the gearbox clutch support structure contains said clutch pipe which movement towards said crank is constrained by an internal flange of said crank bearing.

It is preferable, that the gearbox clutch support structure contains said crank bearing which is an angular contact bearing.

It is preferable, that the gearbox clutch support structure contains a wave spring, which is mounted between said bottom bracket cup and said clutch pipe.

It is preferable, that the gearbox clutch support structure contains said crank which is mounted on an axle.

Further features and advantages of the invention will become more apparent from the following specification when taken in connection with the drawing wherein:

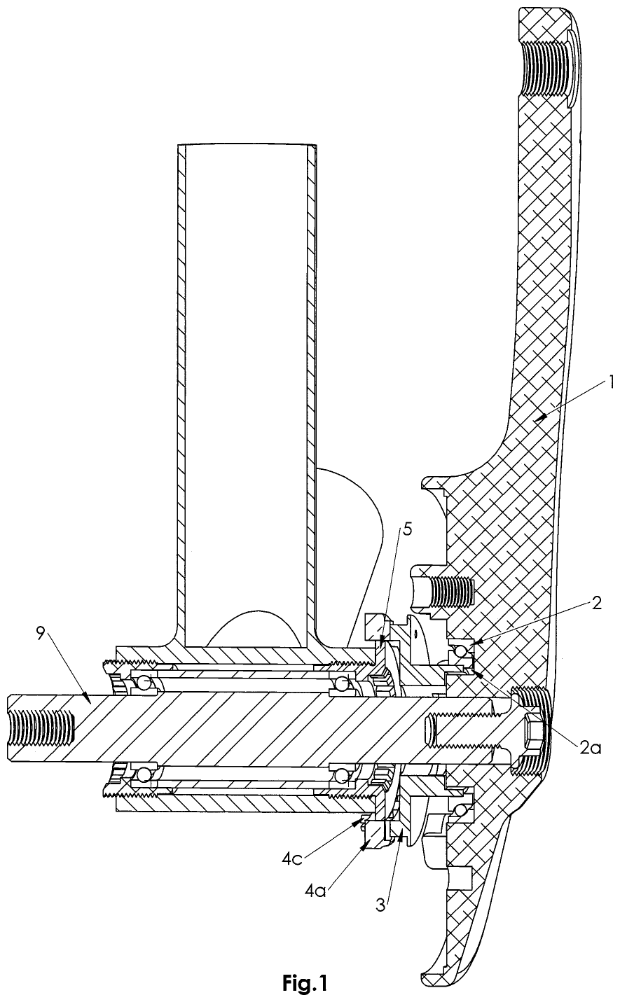

FIG. 1 depicts an axonometric section view of basic elements of the support structure,

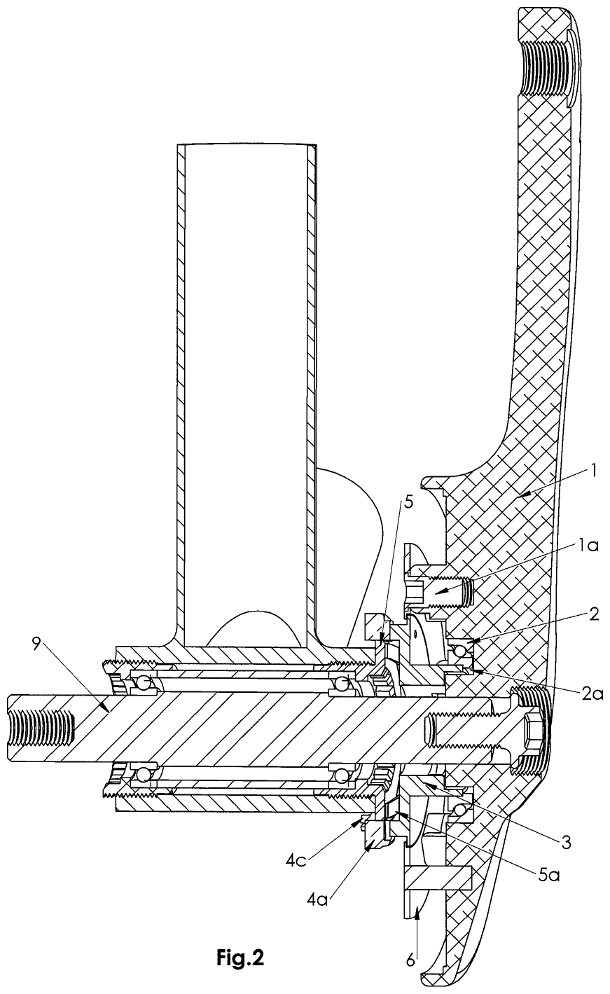

FIG. 2 depicts an axonometric section view of the support structure with visible yoke and wave spring,

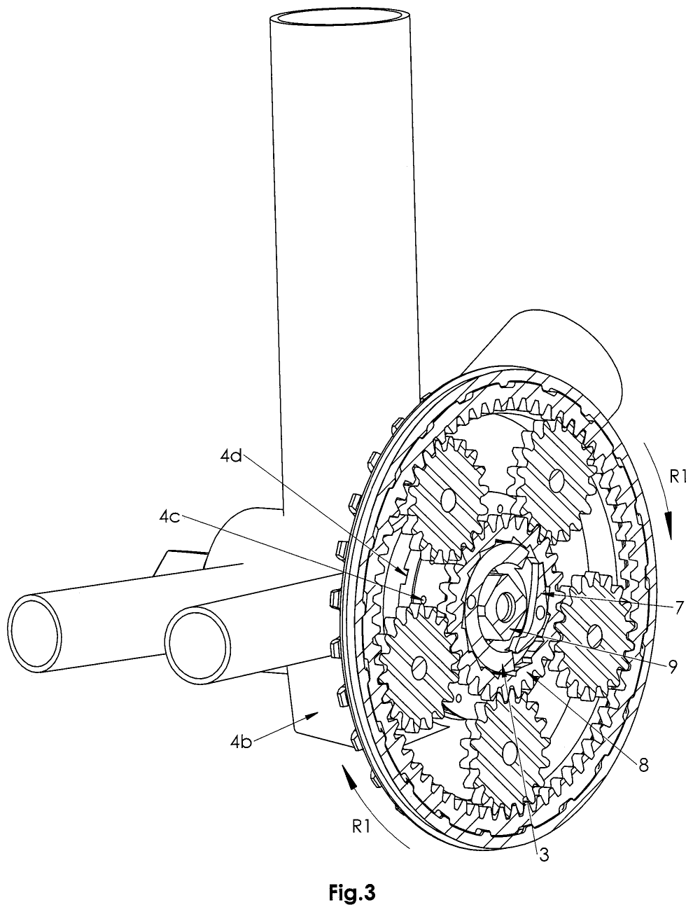

FIG. 3 depicts axonometric section of clutch elements with co-operating gears,

FIG. 4 depicts gearbox in a case, with the leverage blockade shown from the side of the bicycle frame,

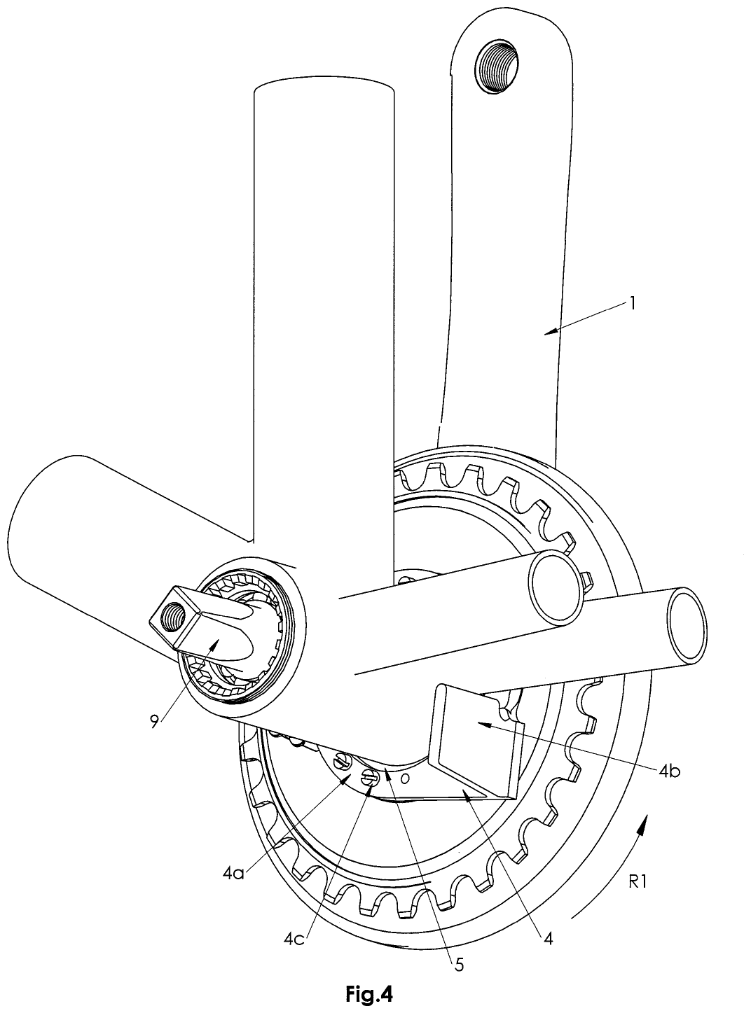

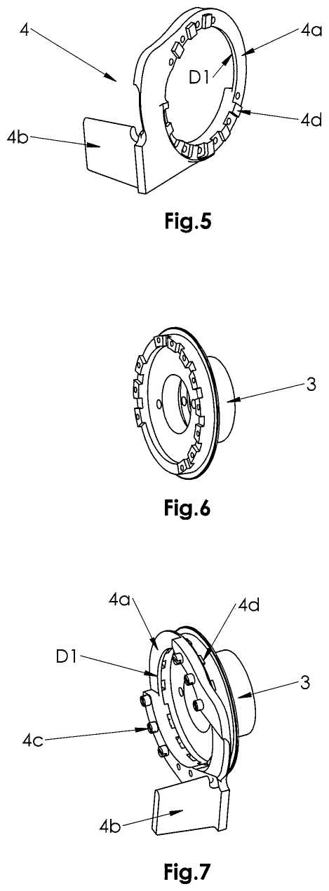

FIG. 5 depicts the leverage,

FIG. 6 depicts the clutch pipe,

FIG. 7 depicts the leverage fixed to the clutch pipe, with the means of spline and bolts,

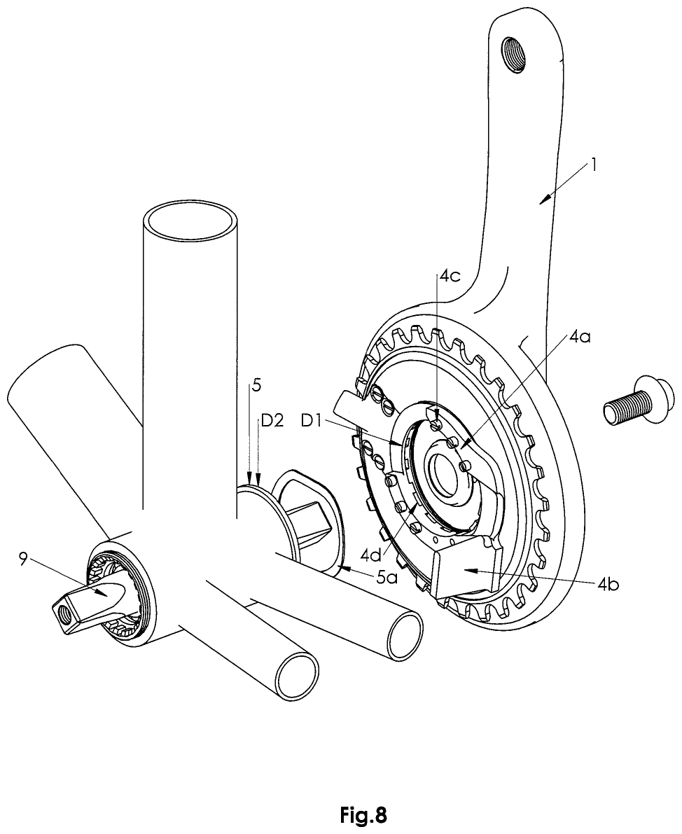

FIG. 8 depicts process of gearbox assembly on the bicycle bottom bracket cup and axle.

The gearbox clutch support structure according to the invention, as shown in FIG. 1-4, consists of crank 1, crank bearing 2, clutch pipe 3, leverage 4, which consists of leverage ring 4a and blockade 4b. Leverage ring 4a is mounted outside of the bottom bracket cup 5. The internal diameter D1 of leverage ring 4a is the same, as the outer diameter D2 of bottom bracket cup 5. The blockade 4b pushes against the bicycle frame in a way, that is makes the ring 4a rotation in R1 direction impossible. As shown in FIG. 5-7, the ring 4a is rigidly fixed to the clutch pipe 3 with leverage bolts 4c and a spline 4d. The clutch pipe 3 is mounted in the crank bearing 2, which is mounted in the crank 1. Movement of the clutch pipe 3 towards the crank 1 is restricted by the internal flange 2a of the crank bearing 2, which is an angular contact bearing. Movement of the clutch pipe 3 away from the crank 1 is restricted by a yoke 6, which is rigidly fixed to the crank 1 with crank bolts la, and a wave spring 5a, which is mounted between the bottom bracket cup 5 and the clutch pipe 3. The wave spring 5a pushes the clutch pipe 3 on to the internal flange 2a of the crank bearing 2, which minimizes friction between the clutch pipe 3 and yoke 6.

The functioning of the gearbox clutch support structure is presented on FIG. 3-4. Rotation of the leverage ring 4a in a forward pedaling direction R1 is made impossible by the blockade 4b. Blocked leverage 4 does not allow for rotation of the clutch pipe 3, in which there is a clutch pawl 7 installed, which further blocks rotation of the sun gear 8, which is part of the epicyclic gearing of the gearbox. Thanks to its firm support on the bottom bracket cup 5 and in the crank bearing 2, the leverage 4 and the clutch pipe 3 together create a stable basis for other clutch elements and allow for their work under high forces from the pedaling biker.

The assembly of the gearbox on the bicycle is relatively easy in comparison to other solutions known from the prior art, as it does not require opening the case of the gearbox. The FIG. 8 shows the assembly process of the gearbox—it is simply installed on the bottom bracket cup 5 and axle 9, with the wave spring 5a put in between the cup 5 and clutch pipe 3.

The invention can be used in front bicycle epicyclic gearboxes, mounted on the bottom bracket axle.

1. The gearbox clutch support structure containing a crank, a crank bearing, a clutch pipe, a leverage and a bottom bracket cup characterized in that it contains said crank bearing (2) that is mounted in said crank (1) and it contains said clutch pipe (3) that is mounted inside of said crank bearing (2), wherein said clutch pipe (3) is rigidly fixed to said leverage (4), wherein said leverage (4) is mounted on said bottom bracket cup (5).

2. The gearbox clutch support structure according to claim 1 further characterized in that it contains said leverage (4) which contains a blockade (4b).

3. The gearbox clutch support structure according to claim 1 further characterized in that it contains said clutch pipe (3) which is used as a basis for other clutch elements.

4. The gearbox clutch support structure according to claim 1 further characterized in that it contains said leverage (4) which rotation in relation to said clutch pipe (3) is blocked by a spline (4d).

5. The gearbox clutch support structure according to claim 1 further characterized in that it contains said leverage (4) which is fixed to said clutch pipe (3) with leverage bolts (4c).

6. The gearbox clutch support structure according to claim 1 further characterized in that it contains a leverage ring (4a) which has an internal diameter (D1), which is equal to the outer diameter (D2) of said bottom bracket cup (5).

7. The gearbox clutch support structure according to claim 1 further characterized in that it contains said clutch pipe (3) which movement away from said crank (1) is constrained by a yoke (6).

8. The gearbox clutch support structure according to claim 1 further characterized in that it contains said clutch pipe (3) which movement towards said crank (1) is constrained by an internal flange (2a) of said crank bearing (2).

9. The gearbox clutch support structure according to claim 1 further characterized in that it contains said crank bearing (2) which is an angular contact bearing.

10. The gearbox clutch support structure according to claim 1 further characterized in that it contains a wave spring (5a), which is mounted between said bottom bracket cup (5) and said clutch pipe (3).

11. The gearbox clutch support structure according to claim 1 further characterized in that it contains said crank (1) which is mounted on an axle (9).
